(19) United States
(12) Patent Application Publication
(10) Pub. No.: US 2018/0088038 A1
(43) Pub. Date: Mar. 29, 2018

(54) GAS DETECTION DEVICE

(71) Applicant: RADIANT INNOVATION INC., Hsinchu City (TW)

(72) Inventors: TSENG-LUNG LIN, HSINCHU CITY (TW); SHAO-YUN YU, HSINCHU CITY (TW); YU-TAI SUNG, HSINCHU CITY (TW)

(21) Appl. No.: 15/274,543

(22) Filed: Sep. 23, 2016

(51) Int. Cl. G01N 21/3504

(52) U.S. Cl. CPC G01N 21/3504

(57) ABSTRACT

The instant disclosure illustrates a gas detection device including a chamber module, a light emitting module, and a light sensor module. The chamber module includes a condenser chamber, a receiving chamber and a sampling chamber. The condenser chamber has a first reflective structure and a second reflective structure. The first reflective structure has a first focal point and a second focal point. The second reflective structure has a center point. The first focal point corresponds to the center point. The light emitting module is disposed on the condenser chamber to generate a light. The light emitting module includes a light emitting unit, wherein the light emitting unit corresponds to the first focal point and the center point. The light sensor module includes a light sensor unit, wherein the light sensor unit is disposed in the receiving chamber.

### BACKGROUND

### 1. Technical Field

The instant disclosure relates to a gas detection device, in particular, to a gas detection device for measuring the concentration of a gas.

### 2. Description of Related Art

The carbon dioxide detection devices or carbon dioxide analyzing instruments in the market generally employ non-dispersive infrared (NDIR) absorption to detect the concentration of the gas. NDIR mainly utilizes a calculation based on Beer-Lambert law. The principle of such analysis is to detect the concentration of a specific gas by utilizing the absorption property of the gas toward infrared light having specific wavelength and the fact that the gas concentration is proportional to the absorption quantity. For example, carbon monoxide has a strongest absorption to a wavelength of 4.7 micron (μm) and carbon dioxide has a strongest absorption to a wavelength of 4.3 micron (μm).

The accuracy and resolution of the gas concentration measuring devices in the market is limited to the structure design of the gas sampling chamber. When the infrared light projected onto the infrared sensor decreases, the accuracy of the measurement of the gas concentration decreases. For example, in Taiwan patent No. 1513973 entitled “Gas Concentration Detection Device”, the structure of the first open end 22 of the detecting unit 2 for receiving the light emitter 3 is not specifically designed to effectively utilize the light generated by the light emitter 3.

In addition, Taiwan patent No. M476923 entitled “High Efficiency Non-dispersive Infrared Gas Chamber” utilizes the bifocal property of an ellipse and disposes the infrared light source at one of the focal points and the infrared sensor at the other focal point, thereby obtaining a high light condensation property and fulfilling the requirement of narrow incident angle of the infrared sensor. However, Taiwan patent No. M476923 increases the length of the infrared gas chamber body 200 by utilizing the bifocal property of an ellipse. Furthermore, the infrared sensor may not be on the correct focal point due to deviation in the assembling process and hence, the signal received by the infrared sensor is decreased.

Moreover, regarding conventional infrared light sensors, when the incident angle of the incident light is larger than 20 degrees, the filter peak will shift toward a short wavelength for about 40 nm (nanometer) due to the wave band width of the filter. Therefore, a part of the light which is not absorbed by the gas to be measured projects on the infrared sensor, and another part of the light which is related to the gas concentration to be measured is blocked from the light sensor and hence, the signal intensity is decreased and the measurement accuracy is reduced.

Therefore, in order to solve the above problems, there is a need to provide a gas detection device for increasing the light condensation, avoiding the effect of assembling error and reducing the length of the gas sampling chamber.

### SUMMARY

The problem to be solved of the instant disclosure is to provide a gas detection device for effectively improving the light condensing property, in which the gas detection device utilizes a light condensing chamber formed by a first reflective structure and a second reflective structure.

In order to solve the above technical problem, an embodiment of the instant disclosure provides a gas detection device comprising a chamber module, a light emitting module and a light sensor module. The chamber module comprises a condensing chamber, a receiving chamber, and a sampling chamber connecting the condensing chamber to the receiving chamber, in which the condensing chamber has a first reflective structure and a second reflective structure connected to the first reflective structure, the first reflective structure has a first focal point and a second focal point corresponded to the first focal point, the second reflective structure has a center point, and the first focal point corresponds to the center point. The light emitting module is disposed on the condensing chamber for generating a light, and the light emitting module comprises a light emitting unit, in which the light emitting unit corresponds to the first focal point and the center point. The light sensor module comprises a light sensor unit disposed in the receiving chamber.

The advantage of the instant disclosure is that the gas detection device provided by the embodiment of the instant disclosure increases the condensing property of the chamber module by the technical features of “the first reflective structure has a first focal point and a second focal point corresponded to the first focal point, the second reflective structure has a center point, and the first focal point and the center point are correspondingly disposed relative to each other” and “the light emitting unit corresponds to the first focal point and the center point”.

In order to further understand the techniques, means and effects of the instant disclosure, the following detailed descriptions and appended drawings are hereby referred to, such that, and through which, the purposes, features and aspects of the instant disclosure can be thoroughly and concretely appreciated; however, the appended drawings are merely provided for reference and illustration, without any intention to be used for limiting the instant disclosure.

### BRIEF DESCRIPTION OF THE DRAWINGS

The accompanying drawings are included to provide a further understanding of the instant disclosure, and are incorporated in and constitute a part of this specification. The drawings illustrate exemplary embodiments of the instant disclosure and, together with the description, serve to explain the principles of the instant disclosure.

FIG. 1 is one of the three-dimensional assembly schematic views of the gas detection device of the first embodiment of the instant disclosure.

FIG. 2 is another three-dimensional assembly schematic view of the gas detection device of the first embodiment of the instant disclosure.

FIG. 3 is one of the three-dimensional exploded schematic views of the gas detection device of the first embodiment of the instant disclosure.

FIG. 4 is another three-dimensional exploded schematic view of the gas detection device of the first embodiment of the instant disclosure.

FIG. 5 is a three-dimensional sectional schematic view of the gas detection device of the first embodiment of the instant disclosure.

FIG. 6 is a side sectional schematic view of the gas detection device of the first embodiment of the instant disclosure.

FIG. 7 is one of the schematic views of the light path of the gas detection device of the first embodiment of the instant disclosure.

FIG. 8 another schematic view of the light path of the gas detection device of the first embodiment of the instant disclosure.

FIG. 9 is a side schematic view of the gas detection device of the first embodiment of the instant disclosure.

FIG. 10 is a side schematic view of one of the implementations of the gas detection device of the first embodiment of the instant disclosure.

FIG. 11 is another side schematic view of one of the implementations of the gas detection device of the first embodiment of the instant disclosure.

FIG. 12 is an enlargement view of part A of FIG. 11.

FIG. 13 is a side schematic view of one of the implementations of the gas detection device of the second embodiment of the instant disclosure.

FIG. 14 is another side schematic view of one of the implementations of the gas detection device of the second embodiment of the instant disclosure.

FIG. 15A is a sectional schematic view of one of the implementations of the gas detection device of the third embodiment of the instant disclosure.

FIG. 15B is another sectional schematic view of one of the implementations of the gas detection device of the third embodiment of the instant disclosure.

FIG. 15C is yet another sectional schematic view of one of the implementations of the gas detection device of the third embodiment of the instant disclosure.

### DESCRIPTION OF THE EXEMPLARY EMBODIMENTS

Reference will now be made in detail to the exemplary embodiments of the instant disclosure, examples of which are illustrated in the accompanying drawings. Wherever possible, the same reference numbers are used in the drawings and the description to refer to the same or like parts.

### First Embodiment

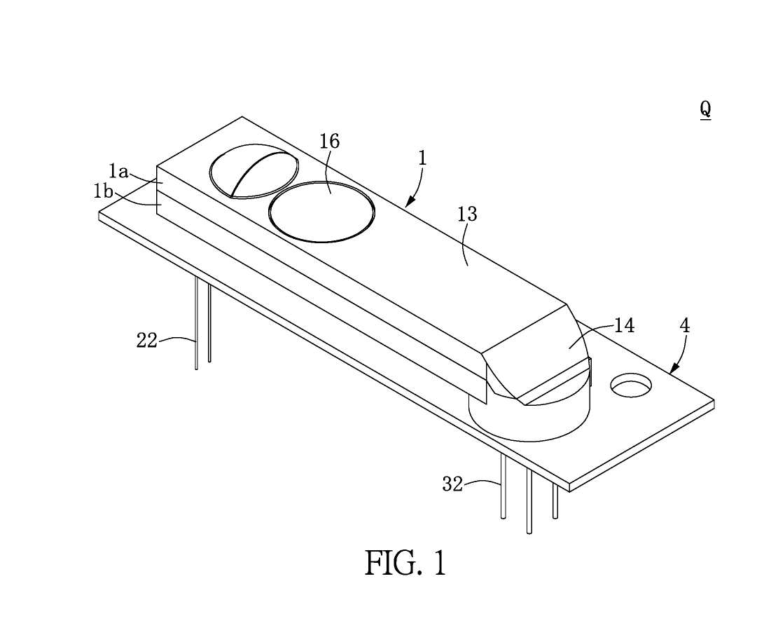

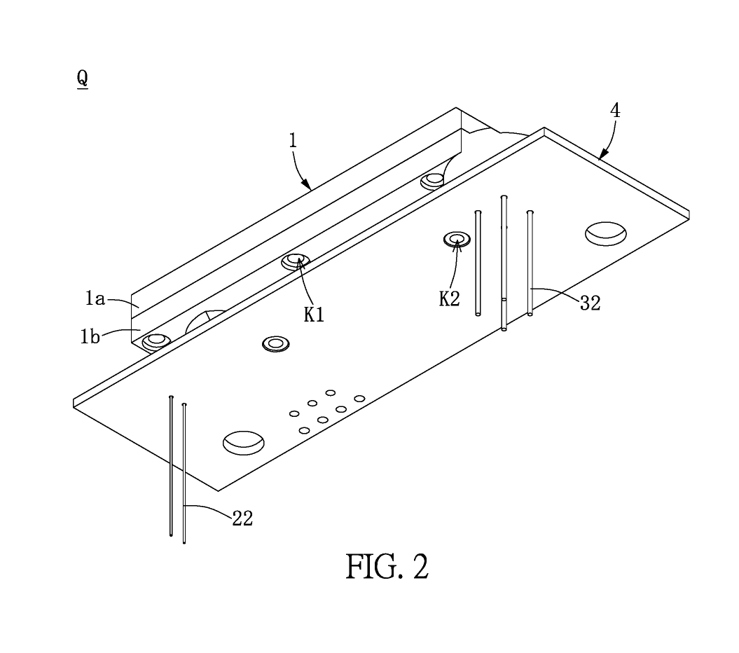

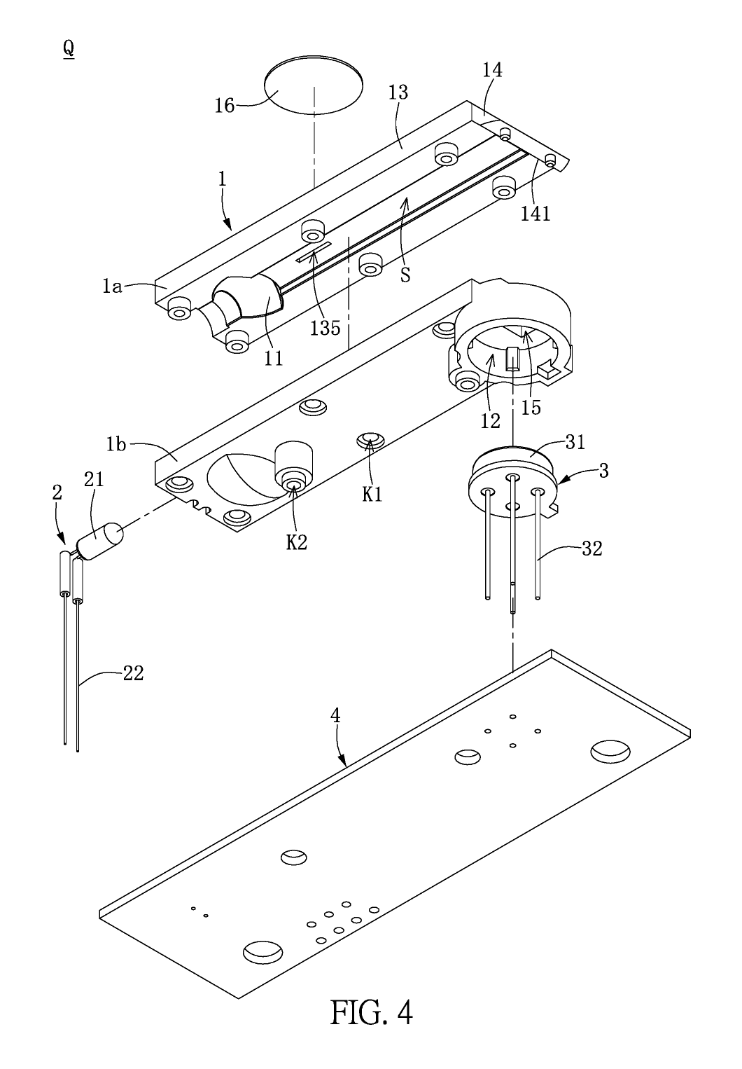

First, please refer to FIG. 1 to FIG. 5. The first embodiment of the instant disclosure provides a gas detection device Q comprising a chamber module 1, a light emitting module 2, a light sensor module 3 and a substrate module 4. The light emitting module 2 and the light sensor module 3 can be electrically connected to the substrate module 4. The substrate module 4 can be electrically connected to a display unit (not shown), a control unit (not shown) and a processing unit. For example, the light emitting module 2 is an infrared light emitter that produces infrared light, and the light sensor module 3 is an infrared light sensor such as a single-beam infrared light emitter or a double-beam infrared light emitter (one of the infrared light collecting windows is for detecting the concentration of the gas and the other is for detecting if the infrared light source decays, and the two infrared light collecting windows can calibrate each other). However, the instant disclosure is not limited thereto.

The gas detection device Q provided by the embodiment of the instant disclosure is able to measure or detect the concentration or other properties of a gas, and the gas to be measured can be carbon dioxide, carbon monoxide or the mixture thereof. The species of the gas to be measured is not limited in the instant disclosure. In other words, by employing different types of light emitting modules 2 and light sensor modules 3, it is able to measure different gases. For example, by changing the wavelength filter (filter plate) on the light sensor module 3, different gases can be measured.

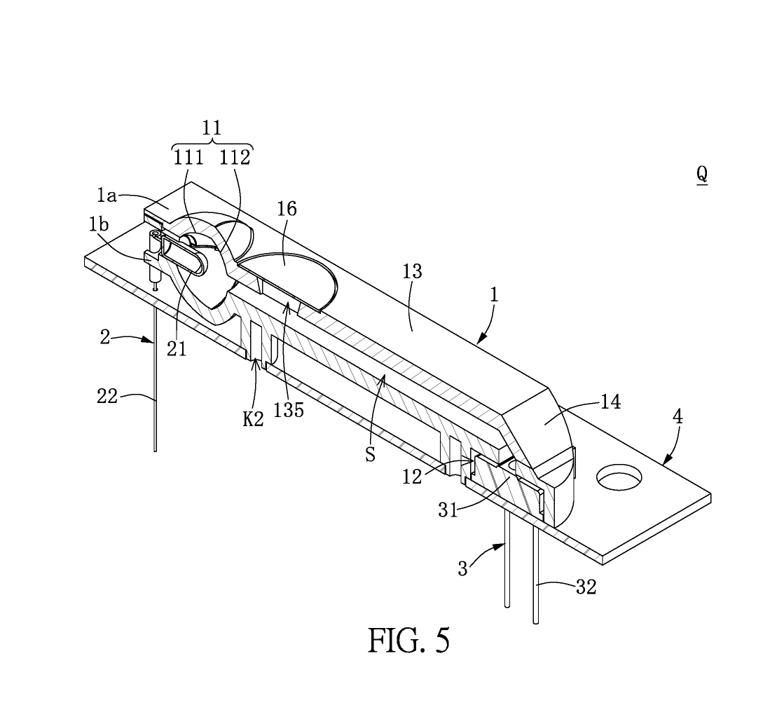

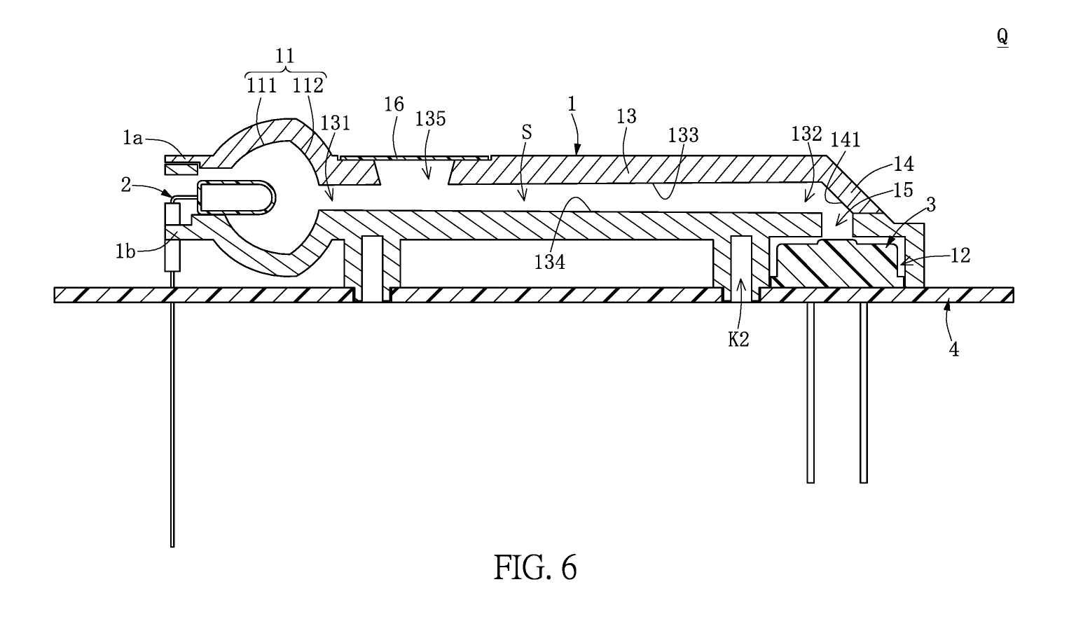

Next, please refer to FIG. 5 and FIG. 6. The chamber module 1 has a sampling space S and comprises a condenser chamber 11, a receiving chamber 12 and a sampling chamber 13 connected to the condenser chamber 11 and the receiving chamber 12. The light emitting module 2 comprises a light emitting unit 21 disposed in the condenser chamber 11 for generating a light T, such as an infrared light. The light sensor module 3 comprises a light sensing unit 31 disposed in the receiving chamber 12 for receiving the light T generated by the light emitting unit 21.

In addition, as shown in FIG. 1 to FIG. 4, the chamber module 1 is constituted by an upper chamber module 1a and a lower chamber module 1b in order to facilitate the assembling process. For example, the upper chamber module 1a and the lower chamber module 1b can be assembled with each other by fixing fixing members (not shown) such as screws in the fixing holes K1. The chamber module 1 can be fixed on the substrate module 4 by fixing the chamber module 1 through fixing members (not shown) into the fixing holes K2. The substrate module 4 is a printed circuit board (PCB) in the embodiments of the instant disclosure, the light emitting module 2 further comprises a connecting line 22, and the light sensor module 3 further comprises a connecting line 32. The connecting line 22 of the light emitting module 2 and the connecting line 32 of the light sensor module 3 can steadily fix the light emitting unit 21 and the light sensing unit 31 on the substrate module 4 by soldering for preventing any loose contact caused by external force.

Please refer to FIG. 5 and FIG. 6. The sampling chamber 13 has a rectangular shape. However, the instant disclosure is not limited thereto. The shape of the sampling chamber 13 will be further discussed in the third embodiment. Each surface inside the sampling chamber 13 such as the upper surface 133, the lower surface 134 and the side surfaces (not numbered) can have a reflective layer (not shown). The reflective layers can be formed inside the sampling chamber 13 by a metal plating or plastic plating process and are formed of gold-containing alloy, nickel or the mixture thereof. The sampling chamber 13 having rectangular shape is a rectangular optical integrator and the working principle thereof is to reflect the light T generated by the light emitting module 2 in the sampling chamber 13 by the reflective layers inside the sampling chamber 13 and generate an integrated light with integrated light intensity, thereby allowing the integrated light T to be uniform.

The sampling chamber 13 further comprises one or more gas diffusion tanks 135 penetrating the upper surface 133 or the lower surface 134 of the sampling chamber 13. The gas diffusion tank 135 can be disposed between the first open end 131 and the second open end 132 of the sampling chamber 13. In addition, the gas diffusion tank 135 has a rectangular shape. Taking FIG. 6 as an example, the sectional view of the gas diffusion tank 135 is in a V shape and hence, based on the Bernoulli effect, the gas to be measured passes through the gas diffusion tank 135 having a V shape and hence, the flow speed thereof increases due to the change of the flow channel cross section, thereby facilitating the gas diffusion and decreasing the measuring time. Furthermore, the chamber module 1 further comprises a gas filtration membrane 16 disposed on the gas diffusion tank 135. The filtration membrane 16 is a waterproof ventilation membrane for avoiding the suspended particulates of the gas to be measured from entering the chamber module 1, causing pollution inside the chamber module 1 and affecting the measurement accuracy.

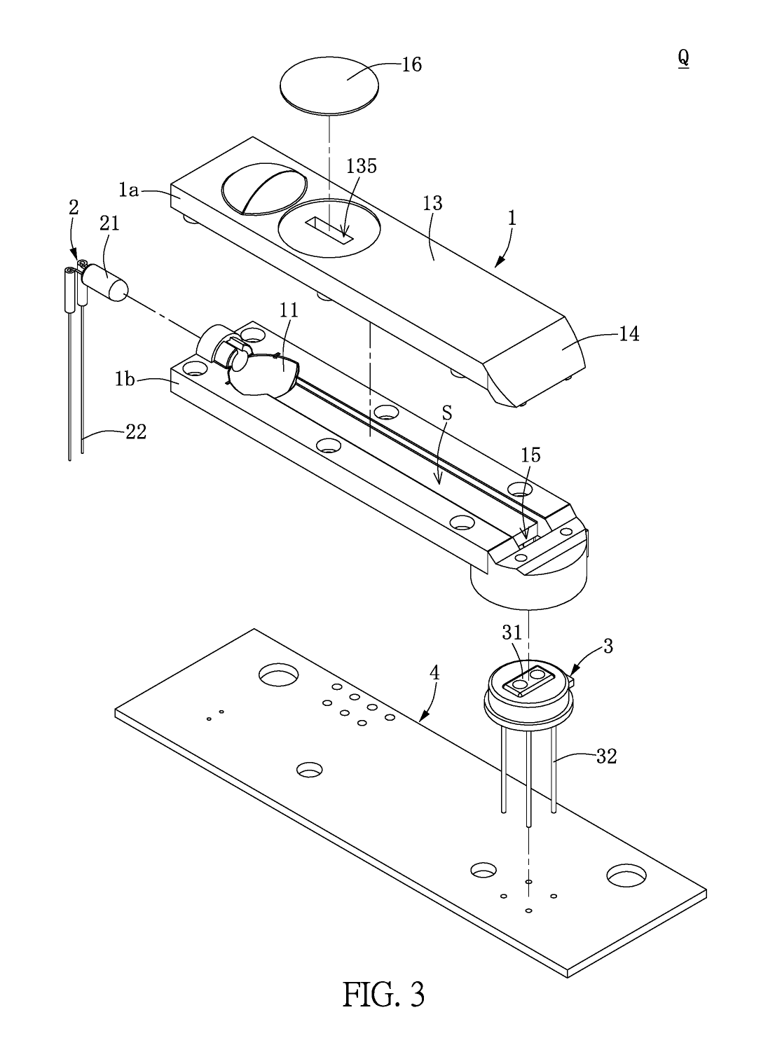

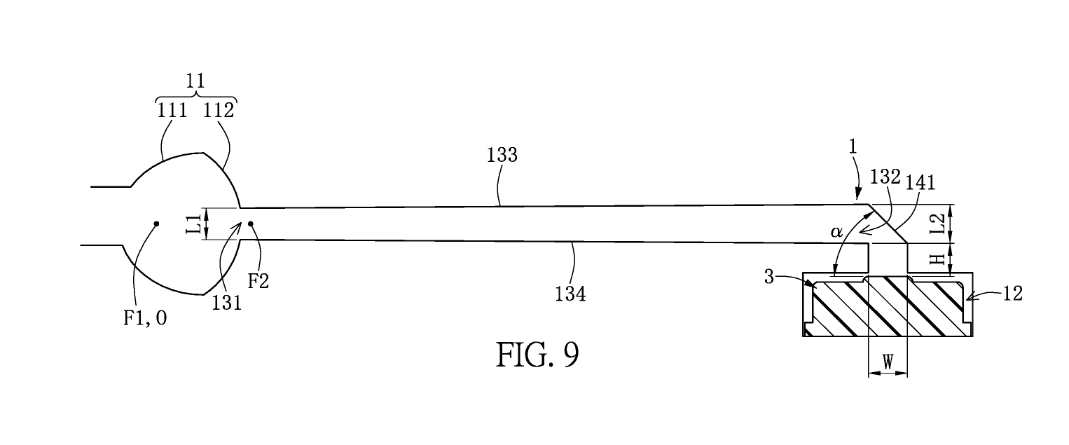

Please refer to FIG. 1, FIG. 3, FIG. 5 and FIG. 6. In the first embodiment of the instant disclosure, the chamber module 1 further comprises a light-guiding portion 14 disposed between the sampling chamber 13 and the receiving chamber 12. The light-guiding portion 14 has a light-guiding surface 141 for reflecting the light T generated by the light emitting unit 21 into the light sensing unit 31. For example, the light-guiding portion 14 can have reflective layers (not shown) coated thereon, or the light-guiding surface 141 is a reflective mirror. However, the instant disclosure is not limited thereto. In addition, the chamber module 1 can further comprise an open slot 15 connecting the light-guiding portion 14 to the receiving chamber 12. The lower surface 134 of the sampling chamber 13 and the light sensing unit 31 has a predetermined height H therebetween (please refer to FIG. 9). Therefore, the light T generated by the light emitting unit 21 is projected onto the light sensing unit 31 from the light emitting unit 21 in a substantially ‘L’ form. In other embodiments (such as in the second embodiment), the light-guiding portion 14 is eliminated, and the light T generated by the light emitting unit 21 is repeatedly reflected by the upper surface 133 and the lower surface 134 and directly projected onto the light sensing unit 31.

Please refer to FIG. 6 to FIG. 8. The structure of the chamber module 1 and the path of the light T projected by the light emitting unit 21 are described below. The condenser chamber 11 has a first reflective structure 111 and a second reflective structure 112 connected to the first reflective structure 111. For example, the first reflective structure 111 and the second reflective structure 112 have different curvatures, in which the first reflective structure 111 has an elliptical curvature surface E and the second reflective structure 112 has a perfect circular curvature C. Therefore, the first reflective structure 111 has a first focal point F1 and a second focal point F2 corresponded to the first focal point F1, the second reflective structure 112 has a center point O, and the first focal point F1 of the first reflective structure 111 and the center point O of the second reflective structure 112 are disposed corresponding to each other. For example, the first focal point F1 and the center point O can overlap with each other. However, the instant disclosure is not limited thereto. In other embodiments, the first focal point F1 and the center point O are disposed adjacent to each other. Preferably, the light emitting unit 21 is directly disposed on the first focal point F1 and the center point O.

The light T comprises a first projected light T11 projected onto the first reflective structure 111 and a second projected light T12 projected onto the second reflective structure 112. The first projected light T11 and the second projected light T12 generated by the light emitting unit 21 is reflected by the curved surface of the first reflective structure 111 and the second reflective structure 112 and form a first light T1 and a second light T2 projected onto the light sensor module 3 respectively.

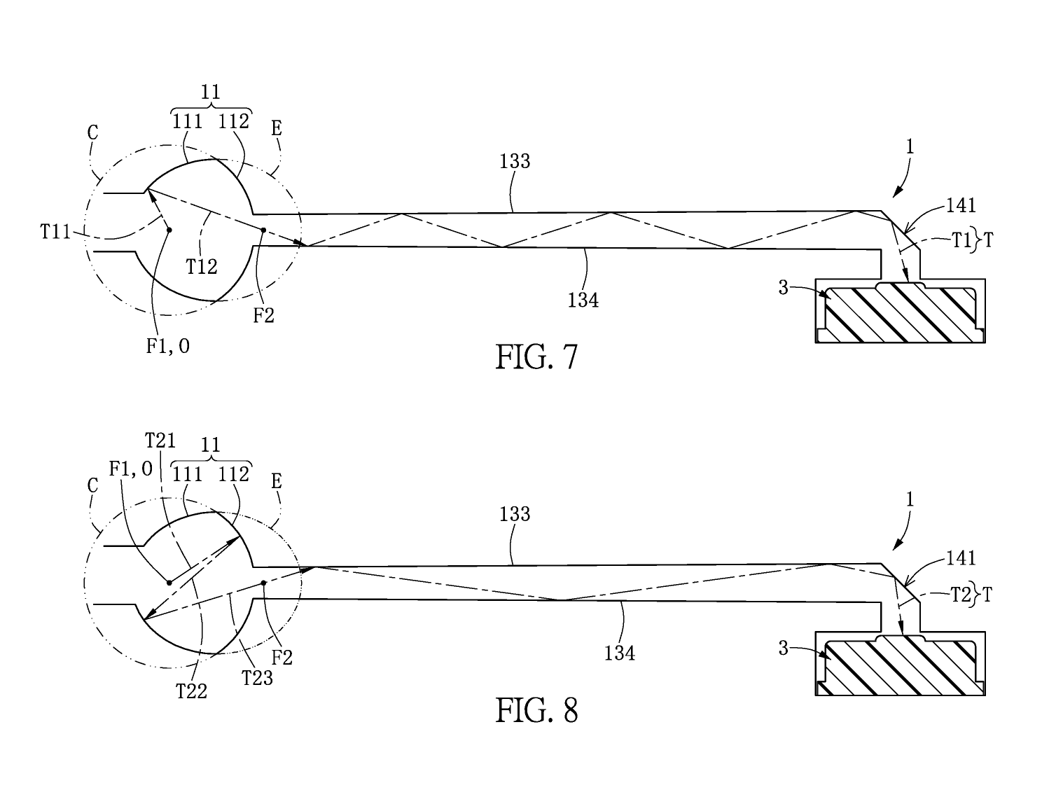

Please refer to FIG. 7. The light path projected from the light emitting unit 21 onto the first reflective structure 111 is described below. Specifically, the first projected light T11 forms a first reflective light T12 projected onto the second focal point F2 of the first reflective structure 111 through the reflection of the first reflective structure 111. Therefore, the first projected light T11 and the first reflective light T12 coordinate with each other and form a first light T1 projected onto the light sensing unit 31. In other words, the first reflective light T12 is repeatedly reflected by the upper surface 133 and the lower surface 134 in the sampling chamber 13 and forms the first light T1 projected onto the light sensing unit 31.

Please refer to FIG. 8. The light path projected from the light emitting unit 21 onto the second reflective structure 112 is described below. The second projected light T21 forms a second reflective light T22 projected onto the first reflective structure 111 by the reflection of the second reflective structure 112. The second reflective light T22 forms a third reflective light T23 projected onto the second focal point F2 of the first reflective structure 111 by the reflection of the first reflective structure 111. The second projected light T21, the second reflective light T22 and the third reflective light T23 coordinate with each other and form a second light T2 projected onto the light sensing unit 31. In principle, the second reflective light T22 passes through the center point O of the second reflective structure 112 and the first focal point F1 of the first reflective structure 111. However, in order to prevent misunderstanding, the second reflective light T22 shown in FIG. 8 is shown not to pass the first focal point F1.

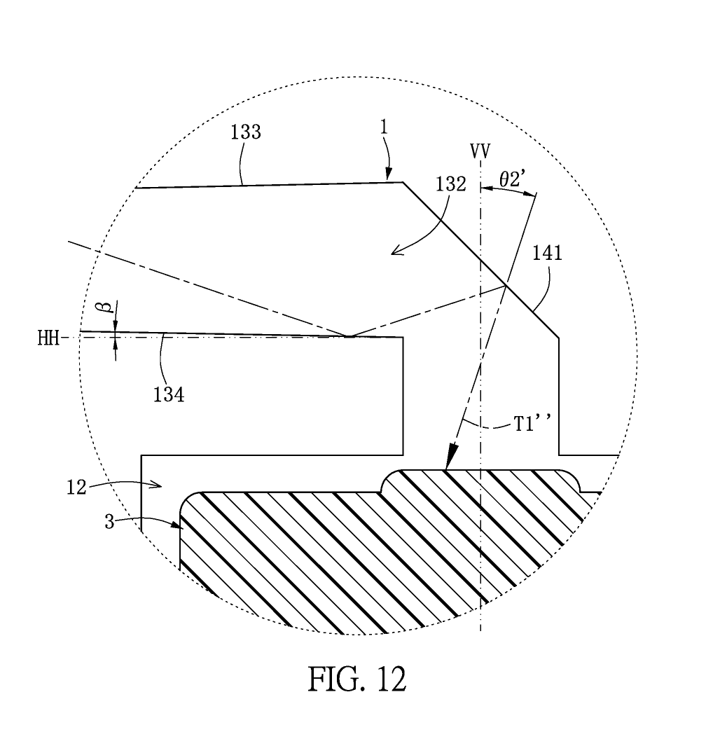

Please refer to FIG. 9. The sampling chamber 13 has a first open end 131 and a second open end 132 corresponding to the first open end 131. The first open end 131 is connected to the condenser chamber 11 and the second open end 132 is connected to the receiving chamber 12. In the first embodiment of the instant disclosure, the light-guiding portion 14 connects the second open end 132 to the receiving chamber 12, the light-guiding surface 141 of the sampling chamber 13 inclines a predetermined angle α (not shown) between 30 to 60 degrees relative to a horizontal axis HH (please refer to FIG. 12). Alternatively, the light-guiding surface 141 of the light-guiding portion 14 inclines (tilts) a predetermined angle α between 30 to 60 degrees relative to the surface of the light sensing unit 31. Preferably, the predetermined angle α is 45 degrees. In other words, the surface of the light sensing unit 31 is parallel to the horizontal axis HH. In addition, preferably, the open slot 15 connects the light-guiding portion 14 to the receiving chamber 12. In FIG. 9, the open slot 15 has a predetermined width W, and the lower surface 134 adjacent to the second open end 132 and the light sensing unit 31 has a predetermined height H, and the predetermined width W and the predetermined height H satisfy the following equation: (0.8*W)≦H≦(3*W), in which the H represents the predetermined height H, and W represents the predetermined width W.

In addition, the upper surface 133 and the lower surface 134 adjacent to the first open end 131 have a first predetermined distance L1 therebetween, and the upper surface 133 and the lower surface 134 adjacent to the second open end 132 have a second predetermined distance L2 therebetween. In the embodiments of the instant disclosure, the first predetermined distance L1 and the second predetermined distance L2 can be different for changing the incident angle of the first reflective light T12 or the third reflective light T23 projected on the light sensing unit 31. Preferably, the second predetermined distance L2 is larger than the first predetermined distance L1. In addition, the predetermined height H and the second predetermined distance L2 satisfy the following equation: (0.8*L2)≦H≦(3*L2), in which the H represents the predetermined height H, and L2 represents the second predetermined distance L2. In other words, the predetermined width W can be equal to the second predetermined distance L2.

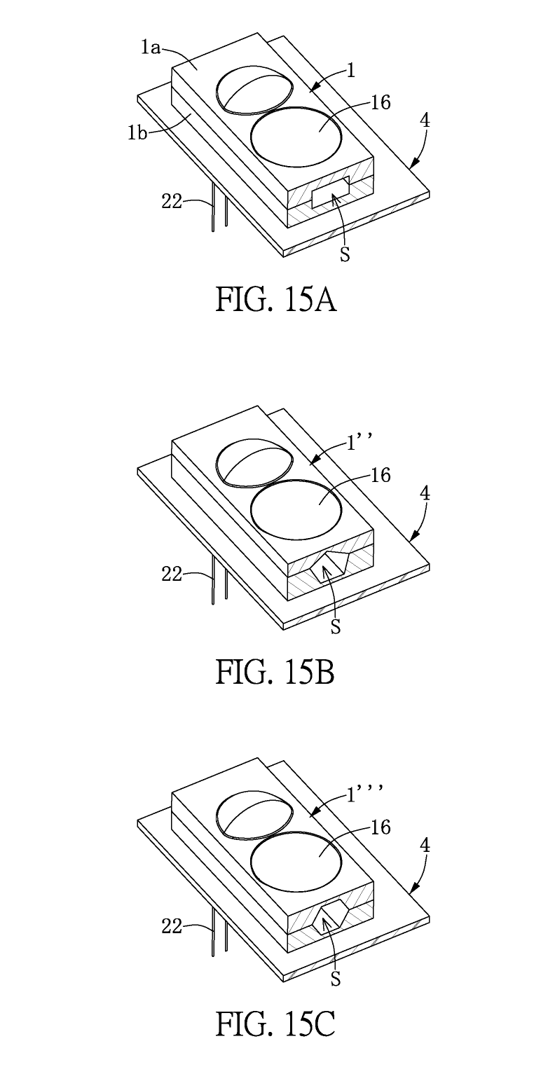

In addition, for example, in the first embodiment of the instant disclosure, the cross section area of the rectangular sampling chamber 13 (please refer to FIG. 15A to FIG. 15C) is larger or equal to the sensing area of the light sensing unit 31. Furthermore, since the dimensions of the existing double-beam infrared sensor are about 4 millimeter (mm)*2 millimeter, the second predetermined distance L2 can be 2.1 mm, and the predetermined width W can be equal to the second predetermined distance L2. However, the instant disclosure is not limited thereto. In other embodiments, the predetermined width W can be between (1.1*L2) to (2.3*L2). The predetermined height H can be between 1 mm to 2 mm preferably, the predetermined height H is 1.5 mm. However, the instant disclosure is not limited thereto.

Next, please refer to FIG. 10 to FIG. 12. The situation in which the first predetermined distance L1 and the second predetermined distance L2 are equal and at which the first predetermined distance L1 and the second predetermined distance L2 is different are described below taking the first light (T1′, T1″) as an example. FIG. 10 shows the condition in which the first predetermined distance L1 and the second predetermined distance L2 are equal. The first reflective light T12′ formed by reflecting the first projected light T11 generated by the light emitting unit 21 by the first reflective structure 111 has a first incidence angle θ1. The first incidence angle θ1 is the angle between the first reflective light T12′ and the lower surface 134 of the sampling chamber 13. The first reflective light T12′ is reflected repeatedly inside the light sensing unit 31, then is reflected by the light-guiding surface 141 which is inclined 45 degrees, and forms a first light T1′ having a second incidence angle θ2 and projected onto the light sensing unit 31. The second incidence angle θ2 is the angle between the vertical axis VV (the axis perpendicular to the surface of the light sensing unit 31) and the first light T1′. For example, since the first predetermined distance L1 and the second predetermined distance L2 are equal, the upper surface 133 of the sampling chamber 13 is parallel to the lower surface 134 of the upper surface 133, and hence, when the first incidence angle θ1 is 23 degrees, the second incidence angle θ2 is 23 degrees as well.

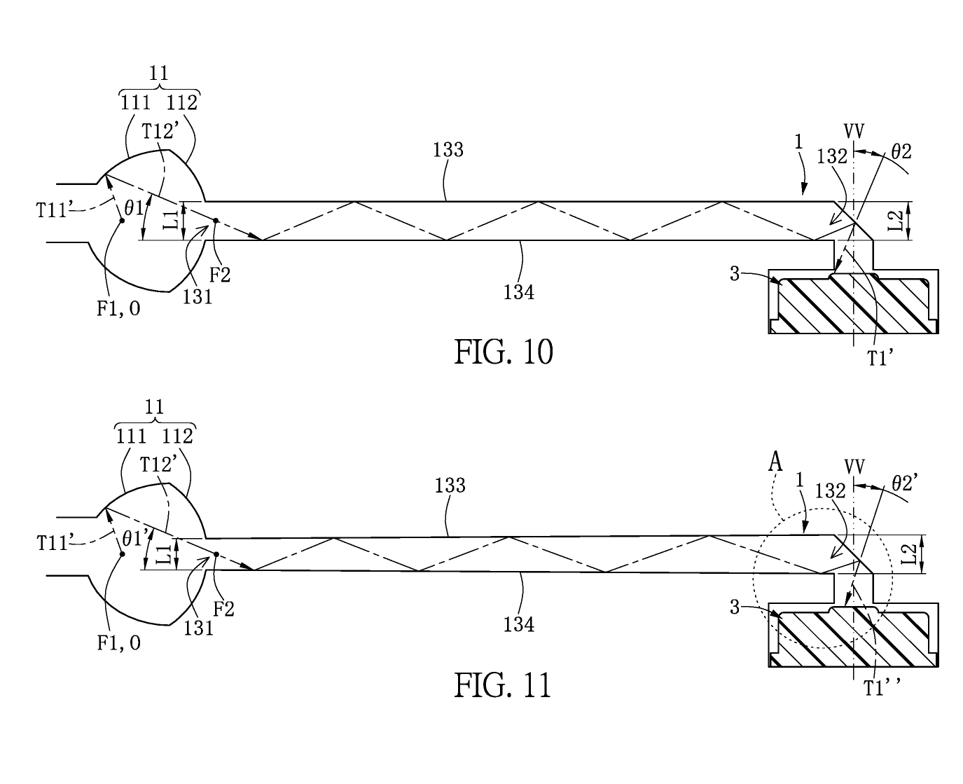

Please refer to FIG. 11 and FIG. 12. FIG. 11 and FIG. 12 show the situation in which the first predetermined distance L1 and the second predetermined distance L2 are different and the second predetermined distance L2 is larger than first predetermined distance L1. The lower surface 134 of the sampling chamber 13 and the horizontal axis HH has an included angle (3 between 0.1 degrees to 5 degrees. Preferably, in the first embodiment of the instant disclosure, the included angle θ is between 0.3 to 3 degree and more preferably, 0.5 degrees. However, the instant disclosure is not limited thereto. The first projected light T11′ generated by the light emitting unit 21 is reflected by the first reflective structure 111 and forms a first reflective light T12′, the first reflective light T12′ has a first incidence angle θ1′. The first reflective light T12′ is repeatedly reflected inside the sampling chamber 13 and reflected by the light-guiding surface 141 which inclines 45 degrees, and forms a first light T1″ having a second incident angle θ2′ and projected onto the light sensing unit 31. For example, since the first predetermined distance L1 and the second predetermined distance L2 are different, i.e., the upper surface 133 of the sampling chamber 13 is not parallel to the lower surface 134, when the first incident angle θ1′ is 23 degrees, the first light T1″ is affected by the included angle β, and the second incident angle θ2′ becomes 18 degrees. Therefore, compared to the situation in which the first predetermined distance L1 and the second predetermined distance L2 are equal, the present situation can receive more infrared light with other wavelengths. In other words, the light T (the first light T1′ and the second light T2) preferably enters the light sensing unit 31 in a direction perpendicular to the surface of the light sensing unit 31. In addition, the instant disclosure does not limit the threshold of the incident angle to 20 degrees and such a value is chosen as an example. In other embodiments, a different light sensing unit 31 can have a preferable incident angle different from less than 20 degrees.

### Second Embodiment

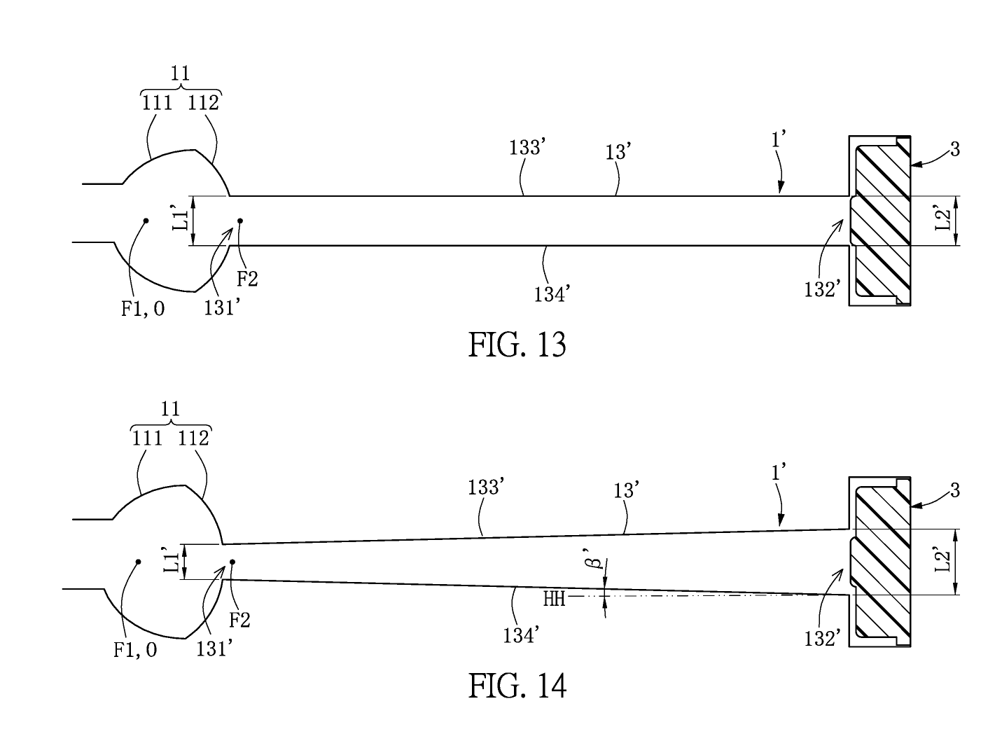

First, please refer to FIG. 13 and FIG. 14. The second embodiment of the instant disclosure provides a gas detection device Q. By comparing FIG. 13 and FIG. 14 with FIG. 10 and FIG. 11, it is able to see the main difference between the second embodiment and the first embodiment which is that the chamber module 1′ provided by the second embodiment does not comprise the light-guiding portion 14 and the open slot 15, and the light T generated by the light emitting unit 21 is directly projected onto the light sensing unit 31. Preferably, the sampling chamber 13 has a first open end 131′, a second open end 132′, an upper surface 133′ and a lower surface 134′.

The upper surface 133′ and the lower surface 134′ at the first open end 131′ has a first predetermined distance L1′ therebetween, the upper surface 133′ and the lower surface 134′ at the second open end 132′ has a second predetermined distance L2′ therebetween. As shown in FIG. 13, the first predetermined distance L1′ and the second predetermined distance L2′ can be equal. However, as shown in FIG. 14, in order to increase the infrared energy that can be received by the light sensing unit 31, the first predetermined distance L1′ and the second predetermined distance L2′ can be different, and the second predetermined distance L2′ can be larger than the first predetermined distance L1′ as described in the previous embodiment. Therefore, the lower surface 134′ of the sampling chamber 13′ and the horizontal axis HH can have an included angle β′ between 0.1 degrees to 5 degrees.

In addition, the light emitting module 2, the light sensor module 3, the condenser chamber 11, the receiving chamber 12 and the sampling chamber 13′ provided by the second embodiment are similar to that of the first embodiment and hence, are not described in detail herein.

### Third Embodiment

First, please refer to FIG. 15A to FIG. 15C. The situations employing different shapes of sampling chamber 13 are described below. For example, the sampling chamber 13 can have a rectangular shape as shown in FIG. 15A. However, the instant disclosure is not limited thereto. In other words, the cross section of the chamber module 1″ can be a pentagon cross section as shown in FIG. 15B, i.e., the chamber modules (1, 1′, 1″, 1′″) can have a cross section of polygon shapes. In addition, the first predetermined distance L1 and the second predetermined distance L2 of the chamber modules (1″, 1′″) having cross sections of pentagon or hexagon shapes can be different (not shown), i.e., the cross section areas of the first open end 131 and the second open end 132 are different.

The chamber module 1 having a rectangular cross section can preferably be adapted to a double-beam infrared light sensor (since the two infrared collection windows are in rectangular shapes). In addition, the chamber module (1″, 1′″) having cross sections of pentagon or hexagon shapes are preferably adapted to a single-beam infrared light sensor (since the infrared collection window of the single-beam infrared light sensor is substantially circular or a square, the chamber modules (1″, 1′″) having cross sections of pentagon or hexagon can be used to surround the infrared collection window).

The chamber modules (1″, 1′″) provided by the third embodiment are similar to that of the previous embodiments and are not described in detail herein. The chamber modules (1″, 1′″) have reflective layers in the inner surfaces thereof for integrating the light T generated by the light emitting module 2 in the sampling chamber 13 and achieving a uniform distribution of the integrated light T.

### Effectiveness of the Embodiments

In summary, the advantage of the instant disclosure is that the gas detection device Q provided by the embodiments of the instant disclosure utilizes the technical features of “the first reflective structure 111 has a first focal point F1 and a second focal point F2 corresponding to the first focal point F1, the second reflective structure 112 has a center point O, and the first focal point F1 and the center point O are disposed corresponding to each other” and “the light emitting unit 21 is corresponded to the first focal point F1 and the center point O,” thereby enhancing the light-condensing property of the chamber modules (1, 1′, 1″, 1′″). In addition, by projecting the first projected light T11 and the third reflective light T23 onto the first opening end (131, 131′) of the sampling chamber (13, 13′), it is able to repeatedly reflect the first projected light T11 and the third reflective light T23 in the sampling chamber (13, 13′).

Moreover, by employing the condenser chamber 11 constituted by the elliptical curvature surface E and the perfect circular curvature C, the lengths of the sampling chambers (13, 13′) are significantly reduced, and the infrared energy projected from the light emitting unit is increased by the light condensing process performed by the first reflective structure 111 and the second reflective structure 112. In addition, after the first reflective light T12 and the third reflective light T23 are projected onto the light-guiding surface 141 having an inclined angle of 45 degrees, the direction of the first reflective light T12 and the third reflective light T23 changes 45 degrees and uniformly projects onto the light sensing unit 31.

In addition, based on the technical feature of “the second predetermined distance L2 is larger than the first predetermined distance L1, the incidence angle (the second incidence angle θ2′) of the light T projected onto the light sensor module 3 (the first light T1 and the second light T2) can be changed, thereby increasing the accuracy of the detection. In other words, by utilizing the sampling chamber 13 having the feature of “the second predetermined distance L2 is larger than the first predetermined distance L1”, the light having the first incidence angle θ1 which is 20 degrees can be transformed into a light projected onto the light sensing unit 31 and having the second incidence angles (θ2, θ2′) less than 20 degrees.

The structure provided by the instant disclosure can solve the problem in the existing art which is the infrared light is not able to be projected onto the light sensing unit 31 due to the assembling tolerances and vibration when the infrared light is concentrated on a single point. Therefore, the light condensing property of the sampling chambers (1, 1′, 1″, 1′″) is increased.

The above-mentioned descriptions represent merely the exemplary embodiment of the instant disclosure, without any intention to limit the scope of the instant disclosure thereto. Various equivalent changes, alterations or modifications based on the claims of the instant disclosure are all consequently viewed as being embraced by the scope of the instant disclosure.

What is claimed is:

1. A gas detection device, comprising:
a chamber module comprising a condensing chamber, a receiving chamber and a sampling chamber connected between the condensing chamber and the receiving chamber, wherein the condensing chamber has a first reflective structure and a second reflective structure connected to the first reflective structure, the first reflective structure has a first focal point and a second focal point corresponded to the first focal point, the second reflective structure has a center point, and the first focal point corresponds to the center point;
a light emitting module disposed on the condensing chamber for generating a light, the light emitting module comprises a light emitting unit, wherein the light emitting unit corresponds to the first focal point and the center point; and
a light sensor module comprising a light sensor unit, the light sensor unit is disposed in the receiving chamber.

2. The gas detection device according to claim 1, wherein the first reflective structure has an elliptical curvature surface, the second reflective structure has a perfect circular curvature surface, and the light emitting unit is disposed on the first focal point and the center point.

3. The gas detection device according to claim 1, wherein the light comprises a first projected light projected on the first reflective structure and a second projected light projected on the second reflective structure, the first projected light is reflected by the first reflective structure and forms a first reflective light projected on the second focal point, the first projected light and the first reflected light together form a first light projected to the light sensor unit, the second projected light is reflected by the second reflective structure and form a second reflective light projected to the first reflective structure, the second reflective light is reflected by the first reflective structure and forms a third reflective light projected to the second focal point, the second projected light, the second reflective light and the third reflective light together form a second light projected to the light sensor unit.

4. The gas detection device according to claim 1, wherein the sampling chamber has a upper surface and a lower surface, the sampling chamber has a first open end and a second open end corresponded to the first open end, the first open end connects to the condensing chamber, the second open end connects to the receiving chamber, the upper surface and the lower surface of the first open end has a first predetermined distance therebetween, the upper surface and the lower surface of the second open end has a second predetermined distance, the second predetermined distance is larger than the first predetermined distance.

5. The gas detection device according to claim 4, wherein the chamber module further comprises a light guiding portion disposed between the sampling chamber and the receiving chamber, the lower surface adjacent to the second open end and the light sensor unit has a predetermined height therebetween, the predetermined height and the second predetermined distance comply with the following equation: (0.8*L2)≦H≦(3*L2), wherein H represents the predetermined height and L2 represents the second predetermined distance.

6. The gas detection device according to claim 1, wherein the chamber module further comprises a light guiding portion disposed between the sampling chamber and the receiving chamber, the light guiding portion has a light guiding surface, the light guiding surface tilts for a predetermined angle of from 30 to 60 degrees relative to a horizontal axis.

7. The gas detection device according to claim 1, wherein the chamber module further comprises a light guiding portion disposed between the sampling chamber and the receiving chamber, and an open slot, the slot connects the light guiding portion to the receiving chamber, the sampling chamber has an upper surface and a lower surface, the open slot has a predetermined width, the lower surface of the sampling chamber and the light sensor unit has a predetermined height therebetween, the predetermined width and the predetermined height satisfy the following equation: (0.8*W)≦H≦(3*W), wherein H represents the predetermined height and W represents the predetermined width.

8. The gas detection device according to claim 1, wherein the sampling chamber further has a gas diffusion tank disposed between the first open end and the second open end.

9. The gas detection device according to claim 1, wherein the light emitting module is an infrared light emitter, the light sensor module is an infrared light sensor.

10. The gas detection device according to claim 1, wherein a cross section of the sampling chamber has a rectangular shape, a pentagon shape or a hexagon shape.
